(19) United States
(12) Patent Application Publication
(10) Pub. No.: US 2024/0043249 A1
(43) Pub. Date: Feb. 8, 2024

(54) DAVIT

(71) Applicant: Safetylink Pty Ltd, Thornton (AU)

(72) Inventors: Oscar William Ratalino, Thornton (AU); Jamie Price, Thornton (AU)

(21) Appl. No.: 18/230,965

(22) Filed: Aug. 7, 2023

(30) Foreign Application Priority Data
Aug. 8, 2022 (AU) 2022902219

(51) Int. Cl. B66C 23/16

(52) U.S. Cl. CPC B66C 23/166

(57) ABSTRACT

A davit used for abseiling purposes and adapted to anchor to a parapet roof includes a davit base assembly and a mast base assembly associated with a mast and configured to rotation about the davit base assembly. The davit base assembly includes a mounting plate sub-assembly adapted to anchor to the roof, and a removable base sub-assembly configured to cooperate with the mounting plate sub-assembly. The mast base assembly includes a roller bearing arrangement configured for contact with a sleeve of the removable base sub-assembly during rotation of the mast and the associated mast base assembly about the davit base assembly.

### TECHNICAL FIELD

The present invention is broadly directed to a davit base assembly and a mast base assembly of a davit. The invention is also generally directed to a demountable mast and boom assembly of a davit. The invention is more particularly directed to an improved davit including the davit base assembly and the mast base assembly of the broader aspects of the invention.

### BACKGROUND OF INVENTION

With davits of a traditional construction used for abseiling purposes there is provided a davit base arrangement anchored to a roof structure and designed to support a mast and associated boom. Davits of this known configuration allow for rotation of the mast and boom about the davit base arrangement. The davit base arrangement typically includes a base plate for permanent anchoring to the roof, and a spigot welded or otherwise fixed to the base plate and designed for removable receipt of the mast for rotation about the davit base arrangement. The spigot extends above the general level of a floor associated with the roof and presents an inconvenient and sometimes unsafe obstacle, particularly if the roof space functions as an entertainment or other pedestrian area.

International patent publication no. WO2020/210858 is directed to a davit base arrangement including a permanently anchored base to which an attachment is detachably fixed. The attachment includes a cylindrical socket for removably supporting a mast of an associated davit. The detachable attachment is twisted about the anchored base to effect removal or latching of the attachment to the base in a bayonet-style action. The davit base arrangement can be partly dismantled wherein the attachment/socket is removed leaving the anchored base below the general level of a floor typically formed by floating tiles and thus no longer presents a trip hazard.

### SUMMARY OF INVENTION

According to a first aspect of the invention there is provided an improved davit comprising:
(1) a davit base assembly comprising:
   a mounting plate sub-assembly adapted to anchor to a roof;
   a removable base sub-assembly including securement means configured to cooperate with the mounting plate sub-assembly wherein sliding movement of the removable base sub-assembly in a linear action effects movement of the securement means into an engaged position for securement of the removable base sub-assembly to the mounting plate sub-assembly, said securement means configured wherein sliding movement of said base sub-assembly in a reciprocal linear action effects movement of said securement means into a disengaged position where the removable base sub-assembly is released for removal from the mounting plate sub-assembly;
(2) a mast base assembly associated with a mast and configured for rotation about the davit base assembly, said mast base assembly including a roller bearing arrangement configured for contact with a sleeve of the removable base sub-assembly during rotation of the mast and the associated mast base assembly about the davit base assembly.

Preferably the roller bearing arrangement is an external roller bearing arrangement configured for contact with an outer-facing surface of the sleeve of the removable base sub-assembly. More preferably the external roller bearing arrangement includes an upper roller bearing sub-assembly including a plurality of circumferentially spaced roller bearings associated with a bearing housing located outside of the sleeve of the davit base sub-assembly, said bearing housing secured to an annular flange of the mast base assembly.

Alternatively the roller bearing arrangement includes an internal roller bearing sub-assembly having a plurality of roller bearings spaced circumferentially about a mast base of the mast base assembly. More preferably the mast base includes a plurality of circumferentially spaced window openings through which respective of the plurality or roller bearings partly protrude for rolling contact with the inner-facing surface of the sleeve of the davit base assembly.

According to a second aspect of the present invention there is provided a davit base assembly comprising:
a mounting plate sub-assembly adapted to anchor to a roof;
a removable base sub-assembly adapted to receive and support a mast base assembly, said removable base sub-assembly including securement means configured to cooperate with the mounting plate sub-assembly wherein sliding movement of the removable base sub-assembly in a linear action effects movement of the securement means into an engaged position for securement of the removable base sub-assembly to the mounting plate sub-assembly, said securement means configured wherein sliding movement of said base sub-assembly in a reciprocal linear action effects movement of said securement means into a disengaged position where the removable base sub-assembly is released for removal from the mounting plate sub-assembly.

Preferably the removable base sub-assembly also includes a locking arrangement configured to cooperate with the mounting plate sub-assembly for movement into a locked position to prevent sliding movement of the removable base sub-assembly thereby retaining the securement means in the engaged position. More preferably the locking arrangement includes a retractable plunger arranged to engage a corresponding aperture in the mounting plate sub-assembly to prevent sliding movement of the removable base sub-assembly whilst the securement means is in the engaged position. Even more preferably the locking arrangement also includes biasing means configured to urge the retractable plunger into engagement with the aperture of the mounting plate sub-assembly.

Preferably the securement means includes a plurality of key elements fixed to and projecting from the removable base sub-assembly, each of said key elements configured for sliding movement in the linear and reciprocal linear actions within respective of a plurality of keyways formed in the mounting plate sub-assembly. More preferably each of the keyways is in the form of a keyhole slot configured at an enlarged end for passage of a corresponding of the key elements in the disengaged position of the securement means, the keyhole slot at an opposing tapered end being effective in retaining the key element for securement of the removable base sub-assembly to the mounting plate sub-assembly in the engaged position of the securement means. Even more preferably the plurality of key elements are each in the form of a bolt having a shank connected to and protruding from the removable base sub-assembly for sliding receipt in the linear and the reciprocal linear actions within respective of the keyhole slots, the bolt including a head connected to the shank and separated from the removable base sub-assembly for retention of the securement means in the engaged position within the keyhole slot for securement of said removable base sub-assembly to the mounting plate sub-assembly.

Preferably the removable base sub-assembly includes a sleeve connected to an end plate, the sleeve being adapted to receive and support the mast base assembly. More preferably the removable base sub-assembly also includes a plurality of radially projecting gussets located outside the sleeve and connected between the end plate and the sleeve to support it under load imposed by the mast base assembly. Even more preferably the key elements of the securement means are fixed to and extend from either the end plate or two or more of the gussets for securement of the removable base sub-assembly to the mounting plate sub-assembly via the securement means in the engaged position.

Alternatively the securement means includes a plurality of keyways formed in the removable base sub-assembly, said keyways configured for movement between the engaged and disengaged positions relative to respective of a plurality of key elements fixed to and projecting from the mounting plate sub-assembly. In this variation the key elements are each in the form of a bolt associated with the mounting plate sub-assembly and arranged for sliding movement within a keyhole slot of the corresponding keyway of the removable base sub-assembly.

Preferably the mounting plate sub-assembly includes an upper plate to which two or more lower mounting rails are fixed, said mounting rails adapted for anchoring to the roof via one or more anchorages whilst providing a space between the roof and an underside of the upper plate to accommodate the securement means of the removable base sub-assembly during its sliding movement and the associated movement of the securement means between the disengaged and engaged positions. More preferably the upper plate includes one or more anchorage openings for passage of respective of the anchorages into the corresponding mounting rail for anchoring of the mounting plate sub-assembly to the roof with the anchorages being located below an upper surface of the upper plate.

According to a third aspect of the invention there is provided a davit and mast base assembly comprising:
a davit base assembly adapted to anchor to a roof;
a mast base assembly associated with a mast and configured for rotation about the davit base assembly, said mast base assembly including an external bearing arrangement configured for contact with an outer-facing surface of a sleeve of the davit base assembly during rotation of the mast and the associated mast base assembly about the davit base assembly.

Preferably the external bearing arrangement includes an upper roller bearing sub-assembly including a plurality of circumferentially spaced roller bearings associated with a bearing housing located outside of the sleeve of the davit base sub-assembly, said bearing housing secured to an annular flange of a mast base of the mast base assembly. More preferably the bearing housing and the annular flange are configured to facilitate rolling contact of the plurality of roller bearings with the outer-facing surface of the sleeve of the davit base assembly

According to a fourth aspect of the invention there is provided a davit and mast base assembly comprising:
a davit base assembly adapted to anchor to a roof;
a mast base assembly associated with a mast and configured for rotation about the davit base assembly, said mast base assembly including an internal roller bearing sub-assembly configured for rolling contact with an inner-facing surface of a sleeve of the davit base assembly during rotation of the mast and the associated mast base assembly about the davit base assembly.

Preferably the internal roller bearing sub-assembly includes a plurality of roller bearings spaced circumferentially about a mast base of the mast base assembly. More preferably the mast base includes a plurality of circumferentially spaced window openings through which respective of the plurality or roller bearings partly protrude for rolling contact with the inner-facing surface of the sleeve of the davit base assembly.

Preferably the mast base of the mast base assembly at its lower end (a) is located inside the sleeve of the davit base assembly, and (b) includes an internal bushing configured for rotational mounting about a fixed axle associated with the davit base assembly. Alternatively the mast base assembly also includes an internal bearing arrangement located at a lower end of the mast base for bearing between an internal surface of the sleeve of the davit base assembly and an outer-facing surface of the mast base.

According to a fifth aspect of the invention there is provided a demountable mast and boom assembly of a davit, said demountable assembly comprising:
a mast at its upper end having a boom mounting bracket;
a removable boom including a tilt pin arranged to slidably cooperate with a slot formed in the boom mounting bracket, said slot configured (a) at a closed end for retention of the tilt pin whilst the removable boom is swung about the tilt pin in a substantially vertical plane from a lowered position to a raised position or vice versa, and (b) at an open end for sliding removal of the tilt pin whilst the removable boom in the lowered position is lifted from the boom mounting backet;
a locking pin retractably associated with the boom mounting bracket and configured for alignment with a locking aperture of the removable boom when it is lifted into the raised position with the tilt pin retained within the closed end of the slot of the boom mounting bracket.

Preferably the boom mounting bracket includes a pair of opposing mounting plates fixed to the upper end of the mast, said mounting plates located either side of a corresponding pair of mounting plates associated with the removable boom. More preferably the slot of the boom mounting bracket is one of a pair of slots formed in respective of the opposing mounting plates. Even more preferably the tilt pin extends between and protrudes either side of the corresponding mounting plates of the removable boom, said tilt pin at its opposing ends configured for sliding receipt within the open end of respective of the pair of slots of the opposing mounting plates.

Preferably the tilt pin is longitudinally offset toward a proximal end of the removable boom relative to its centre of gravity whereby biasing weight forces of said boom promote tilting of the boom toward the lowered position and retention of the tilt pin at the closed end of the slot of the boom mounting bracket. More preferably the slot of the boom mounting bracket is of an orientation which substantially aligns with a longitudinal axis of the removable boom in the lowered position thereby permitting sliding removal of the tilt pin from the open end of the slot by lifting of the boom in a general direction of said longitudinal axis.

Preferably the locking aperture of the removable boom is one of a pair of locking apertures formed in respective of the corresponding pair of mounting plates of said boom, said locking apertures being longitudinally spaced from the tilt pin toward the proximal end of the removable boom. More preferably the locking pin is retractably received within a pair of opposing pin apertures formed in respective of the pair of opposing mounting plates of the boom mounting bracket, said pin apertures aligning of the pair of locking apertures with the removable boom with said boom in the raised position and the tilt pin in retention with the closed end of the slot.

### BRIEF DESCRIPTION OF DRAWINGS

In order to achieve a better understanding of the nature of the present invention a preferred embodiment of an improved davit together with other aspects of the invention will now be described, by way of example only, with reference to the accompanying drawings in which:

FIG. 1 is a side elevation of an improved davit of a preferred embodiment of a first aspect of the invention;

FIG. 2 is an isometric view of the improved davit of the embodiment of the first aspect of FIG. 1 associated with a roof;

FIGS. 3 and 4 are isometric views of a davit base assembly of a preferred embodiment of a second aspect of the invention taken from the improved davit of FIGS. 1 and 2 and shown anchored to the roof in an assembled and dis-assembled configuration;

FIGS. 5 and 6 are isometric and sectional views of the davit base assembly of the embodiment of the second aspect of the invention taken from FIG. 3;

FIG. 7 is an isometric view of the davit base assembly of the embodiment of the second aspect of the invention taken from FIG. 4 and shown in the dis-assembled configuration;

FIG. 8 is an isometric view of another embodiment of a davit base assembly of the second aspect of the invention shown in the dis-assembled configuration;

FIG. 9 is an isometric view of a further embodiment of a davit base assembly of the second aspect of the invention shown in the dis-assembled configuration;

FIG. 10 is an isometric view shown partly exploded of a davit and mast base assembly of a preferred embodiment of a third aspect of the invention taken from the improved davit of FIGS. 1 and 2;

FIG. 11 is an isometric view of an external bearing arrangement removed from the davit and mast base assembly of the embodiment of the third aspect of the invention of FIG. 10;

FIG. 12 is an isometric view of a davit and mast base assembly of a preferred embodiment of a fourth aspect of the invention;

FIGS. 13 to 16 are isometric views of a demountable mast and boom assembly of a preferred embodiment of a fifth aspect of the invention shown in various states of assembly.

### DETAILED DESCRIPTION

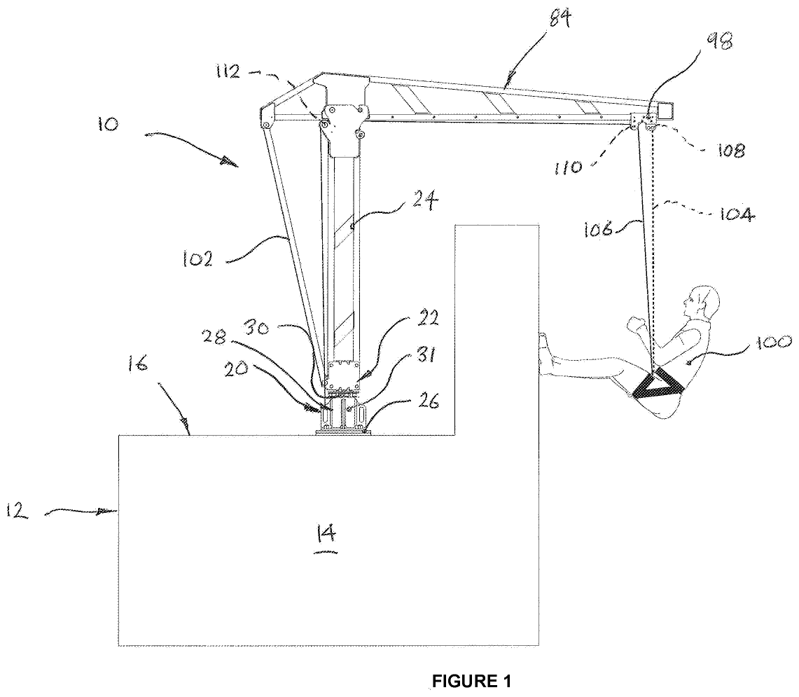

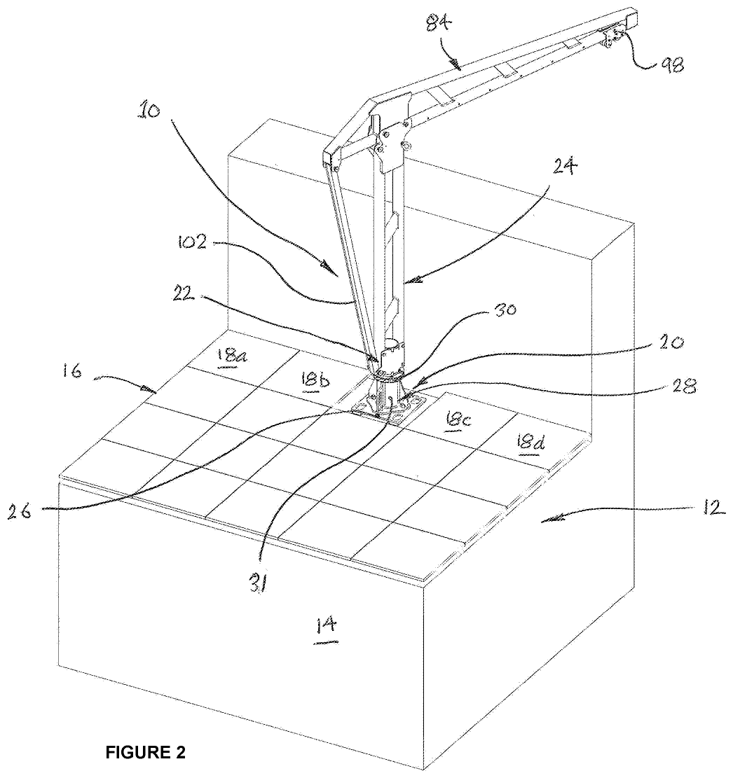

FIGS. 1 and 2 show an improved davit 10 used for abseiling purposes and in this embodiment of the first aspect of the invention adapted to anchor to a roof such as parapet roof 12. The parapet roof 12 is of a conventional construction including a structural roof substrate 14 of concrete and reinforcing steel together with a floor 16 having removable and floating tiles such as 18a to 18d. One of the floating tiles (not shown) is temporarily removed from neighbouring tiles 18b and 18c for installation of the improved davit 10 of this aspect of the invention.

In this embodiment of the first aspect, the improved davit 10 broadly comprises:
1. a davit base assembly 20;
2. a mast base assembly 22 associated with a mast 24 and configured for rotation about the davit base assembly 20.

In this example of the first aspect, the davit base assembly 20 comprises a mounting plate sub-assembly 26 adapted to anchor to the roof 12, and a removable base sub-assembly 28 configured to cooperate with the mounting plate sub-assembly 26. The mast base assembly 22 includes roller bearing arrangement 30 configured for contact with a sleeve 31 of the removable base sub-assembly 28 during rotation of the mast 24 and the associated mast base assembly 22 about the davit base assembly 20.

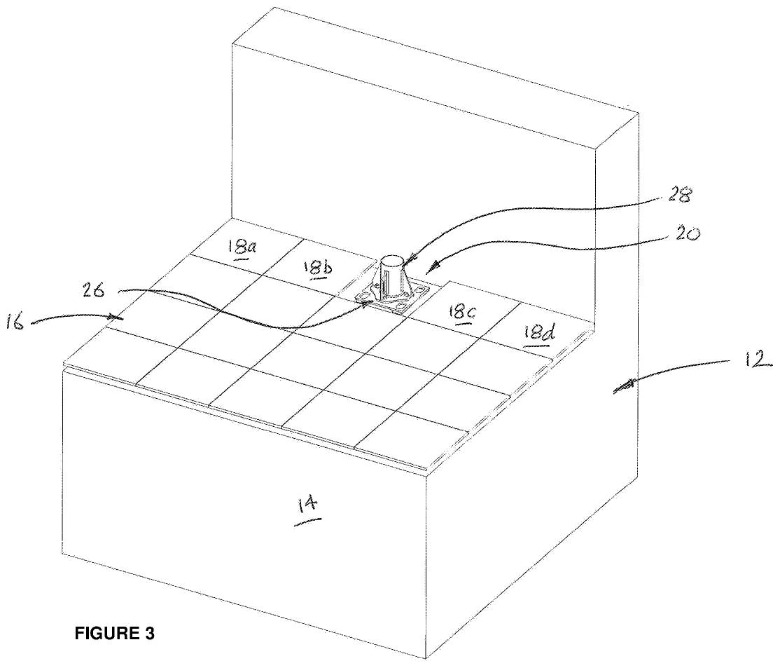

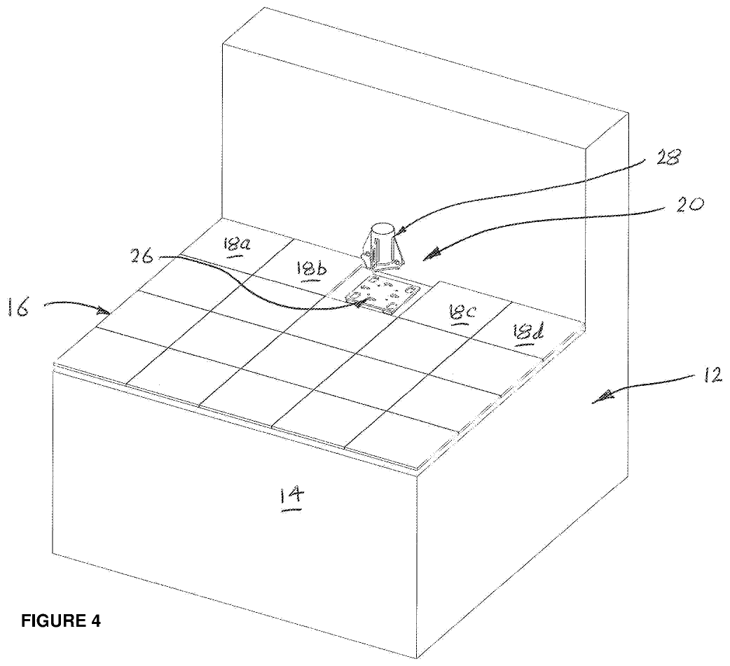

FIGS. 3 to 7 illustrate the davit base assembly 20 taken from the improved davit 10 of FIGS. 1 and 2 and constructed in accordance with a preferred embodiment of a second aspect of the invention. In this example of the second aspect, the davit base assembly 20 broadly comprises:
1. the mounting plate sub-assembly 26 adapted to anchor to the roof 12;
2. the removable base sub-assembly 28 arranged to cooperate with the mounting plate sub-assembly 26 and adapted to receive and support the mast base assembly 22.

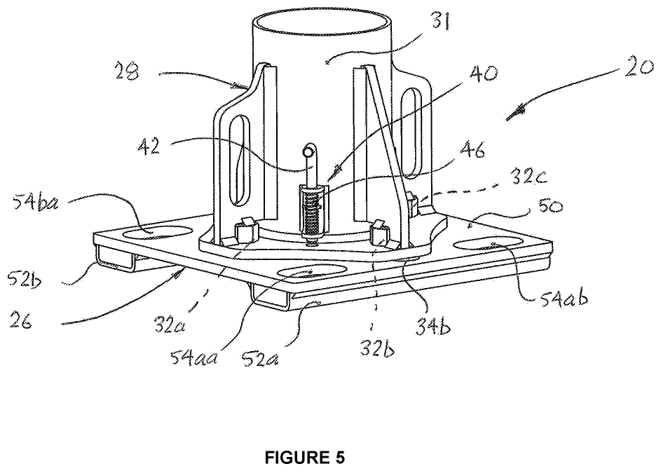

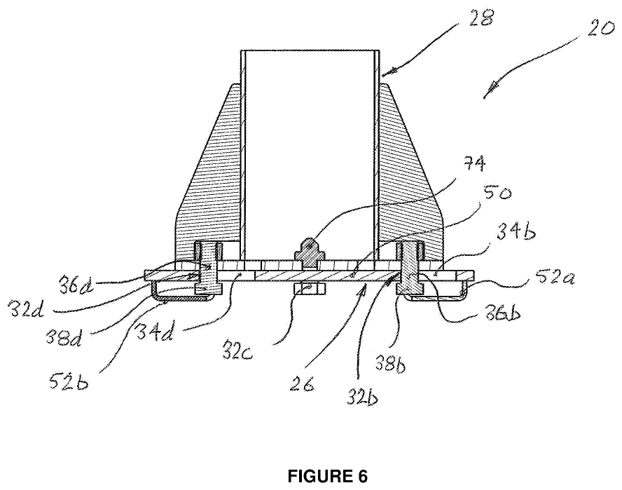

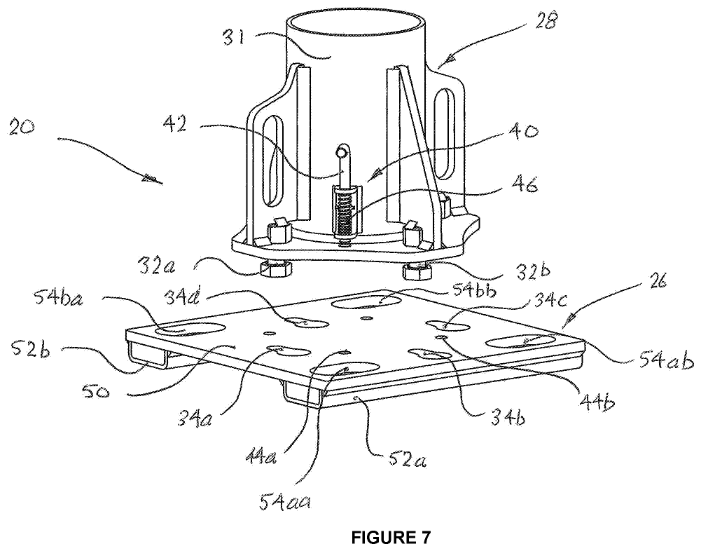

As best illustrated in FIGS. 5 to 7, the removable base sub-assembly 28 of this embodiment of the second aspect of the invention includes securement means configured for securement of the removable base sub-assembly 28 to the mounting plate sub-assembly 26. In the embodiment shown, the securement means includes a plurality of key elements 32a to 32d configured for keying within respective of a plurality of keyways 34a to 34d formed in the mounting plate sub-assembly 26. It will understood that sliding movement of the removable base sub-assembly 28 in a linear action effects movement of the key elements 32a to 32d into an engaged position (see FIGS. 5 and 6) for securement of the removable base sub-assembly 28 to the mounting plate sub-assembly 26. Conversely, it will be understood that sliding movement of the base sub-assembly 28 in a reciprocal linear action effects movement of the key elements 32a to 32d to a disengaged position where the removable base sub-assembly 28 is released for removal from the mounting plate sub-assembly 26 (see FIG. 7).

As best seen in FIGS. 6 and 7, the key elements 32a to 32d are configured for sliding movement in the linear and reciprocal and linear actions within respective of the plurality of keyways 34a to 34d formed in the mounting plate sub-assembly 26. The key elements 32a to 32d are each in the form of a bolt, and the keyways 34a to 34d are each in the form of a keyhole slot. As best seen in FIG. 6, each of the bolts such 32b/d includes a shank 36d/b and a head 38b/d separated from the removable base sub-assembly 28 for retention of the securement means or key element 32b in the engaged position within the keyhole slot 34b/d. In this example, the keyhole slot such as 34b is configured at an enlarged end for passage of the bolt 32b in the disengaged position of the securement means. It will be understood that the keyhole slot such as 34b at an opposing tapered end is effective in retaining the head 38b of the bolt 32b or other key element for securement of the removable base sub-assembly 28 to the mounting plate sub-assembly 26 in the engaged position of the securement means. In this embodiment, the keyhole slots 34a to 34d are aligned substantially parallel to one another wherein sliding movement of the base sub-assembly 28 in the linear and reciprocal linear actions effects movement of the securement means between the disengaged and engaged positions.

As seen in FIGS. 5 and 7, the removable base sub-assembly 28 also includes a locking arrangement 40 configured to cooperate with the mounting plate sub-assembly 26. The locking arrangement 40 in its locked position is effective in preventing sliding movement of the removable base sub-assembly 28 thereby retaining the securement means such as 32a to 32d in the engaged position. In this example, the locking arrangement 40 includes a retractable plunger 42 arranged to engage a corresponding aperture such as 44a in the mounting plate sub-assembly 26. The retractable plunger 42 is urged via biasing means in the form of compression spring 46 into engagement with the aperture such as 44a of the mounting plate sub-assembly 26. It will be understood that the locking arrangement 40 is configured wherein the retractable plunger 42 aligns with the corresponding aperture such as 44a only once the securement means such as 32a to 32d is moved via the removable base sub-assembly 28 into the engaged position.

The retractable plunger 42 must be retracted against the biasing force of the compression spring 46 to release from the aligned aperture 44a prior to sliding of the removable base 28 in the reciprocal linear action for its release and removal from the mount plate sub-assembly 26. It is also to be understood that the symmetrical arrangement of the securement means 32a to 32d and the corresponding keyways 34a to 34d means that securement of the base sub-assembly 28 to the mounting plate sub-assembly 26 can be achieved in any one of four rotational orientations. For example, counter clockwise rotation of the removable base sub-assembly 28 ninety (90) degrees from the orientation shown means that key elements and keyways such as 32a and 34b nonetheless align for receipt and engagement. With the securement means such as 32a to 32d in the engaged position, the retractable plunger 42 aligns for locking with another corresponding aperture such as 44b of the mounting plate sub-assembly 26.

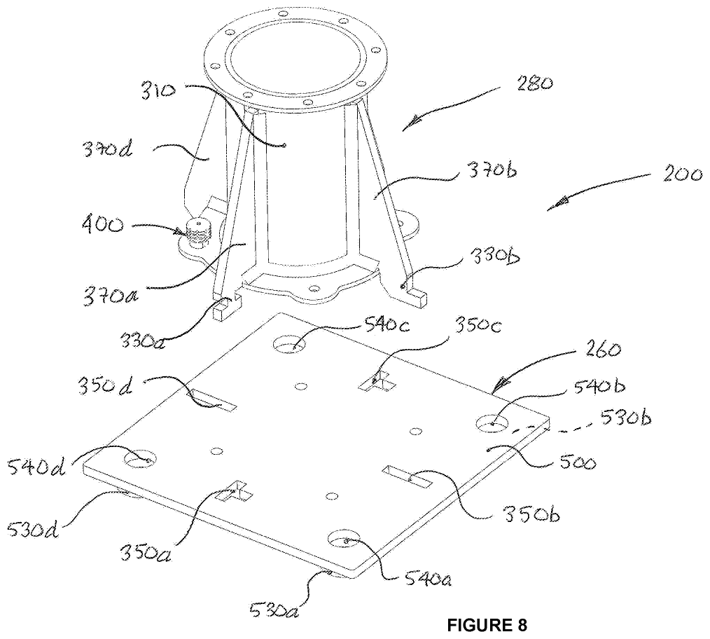

FIG. 8 illustrates another embodiment of a davit base assembly of the second aspect of the invention. This alternative embodiment is of similar construction to the preceding embodiment and like components are indicated with an additional “0”, for example the davit base assembly is designated as 200. In this variation the davit base assembly 200 departs from the preceding embodiment insofar as:
1. the key elements are arranged as two opposing pair of key elements 330a/c and 330b/d and associated keyways 350a/c and 350b/d;
2. the key elements 330a to 330d are fixed to and extend from respective of radially projecting gussets 370a to 370d of the removable base assembly 280.

One of the pair of opposing key elements 330a/c extends from the corresponding gussets 370a/c in the form of an inverted “T” oriented in a vertical plane and configured for receipt and slidable engagement with corresponding keyways 350a/c in the form of T-shaped slots oriented in a horizontal plane. The other of the pair of key elements 330b/d extend from corresponding gussets 370b/d in a substantially vertical plane in the form of an inward and an outwardly directed “L” configured for receipt and slidable engagement with the corresponding keyhole slot 350b/d which is substantially straight.

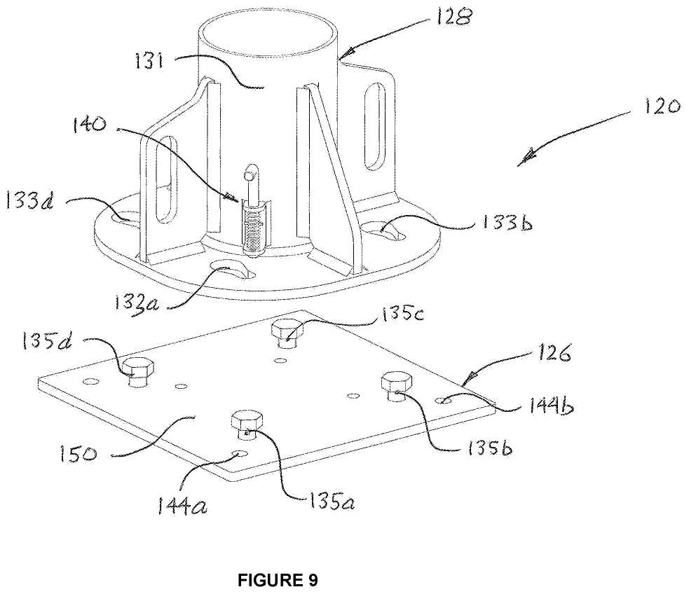

FIG. 9 depicts a further embodiment of a davit base assembly of the second aspect of the invention being similar to but of a reverse configuration to the preferred embodiment of FIG. 7. In this variation the davit base assembly has been referenced with corresponding components prefixed with a “1”, for example the davit base assembly is designated as 120. The securement means of the removable base sub-assembly 128 includes a plurality of keys 133a to 133d each taking the form of a keyhole slot. The keyhole slots such as 133a to 133d cooperate with respective of a plurality of bolts 135a to 135d connected to the mounting plate sub-assembly 126. The sliding movement of the removable base sub-assembly 128 for securement with the mounting plate sub-assembly 26 is in accordance with the linear action of the preferred embodiment. Likewise, the locking arrangement 140 is effective in retaining the securement means such as the keyways or keyhole slots 133a to 133d in the engaged position preventing sliding movement of the removable base sub-assembly 128.

Returning to FIGS. 5 to 7, the mounting plate sub-assembly 26 includes an upper plate 50 to which a pair of lower mounting rails 52a and 52b are fixed. The mounting rails 52a/b serve two primary functions in:
1. permitting anchoring of the mounting plate sub-assembly 26 to the roof 12 via a plurality of anchorages (not shown);
2. raising the upper plate 50 above the concrete/steel substrate 14 providing a space to accommodate the securement means such as 32a to 32d during sliding movement of the removable base sub-assembly 28 between the disengaged and engaged position and vice a versa.

The upper plate 50 of the mounting plate sub-assembly 26 includes anchorage openings 54aa/ab and 54ba/bb for passage of respective of the anchorages into the corresponding mounting rail 52a/b. Although not illustrated, the anchorages are of a similar construction to that described in the applicant's International patent publication no. WO2021/119724. The contents of this specification are to be understood as incorporated herein by way of this reference. The anchorage openings 54aa/ab and 54ba/bb are in this example elongate and sized to accommodate a fixing tester for applying a pull-out force to respective of the anchorages.

In the other embodiment of the second aspect of FIG. 8, the mounting rails 52a/b of the preferred embodiment with four chair mounts 530a to 530d dedicated to respective anchorages. In this variation the upper plate 500 includes anchorage openings 540a to 540d in the form of enlarged and circular-shaped openings for passage of respective of the anchorages into the corresponding chair mounts 530a to 530d.

In the further embodiment of the second aspect of FIG. 9, the mounting plate sub-assembly 126 is limited to the upper plate 150 without either the mounting rails 52a/b or chair mounts 530a to 530d of the preceding embodiments. In this variation there is no requirement for a space between the roof 12 and an underside of the mounting plate 150 because the securement means of the removable base sub-assembly 128 takes the form of keyways or keyhole slots 133a to 133d which do not project beneath the removable base sub-assembly 128. Rather, in this “reversed” design the bolts are fixed to and project upward from the mounting plate sub-assembly 126 for engagement with the keyhole slots 133a to 133d.

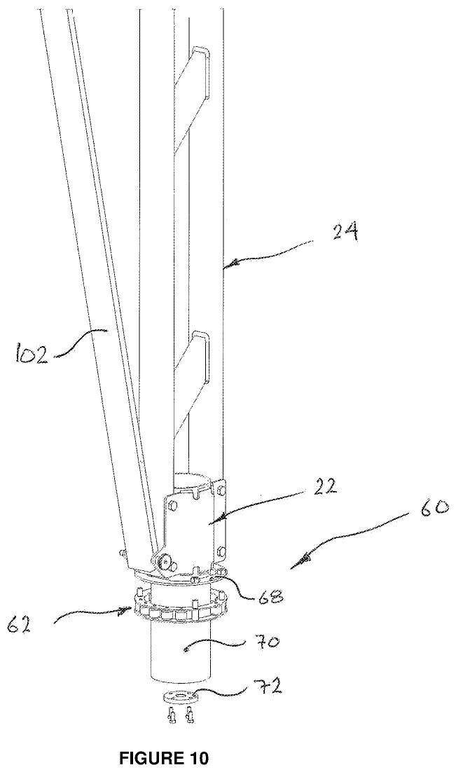

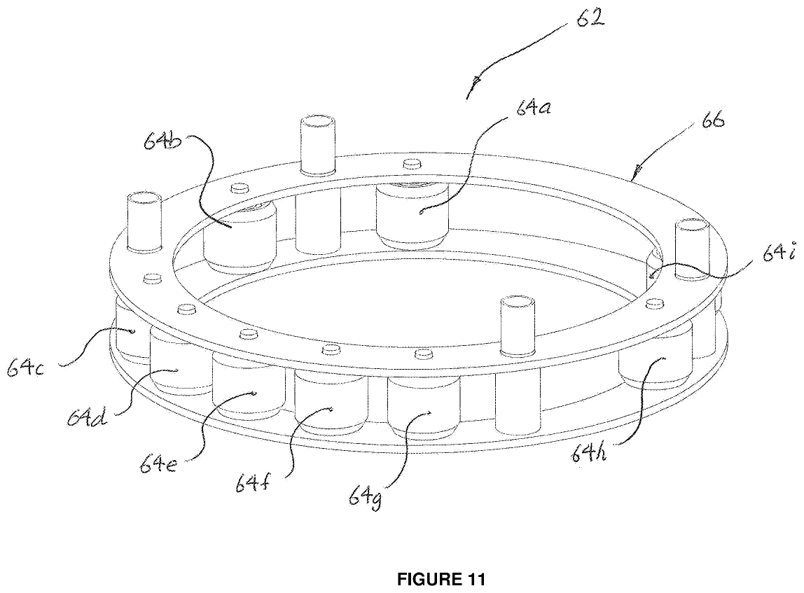

FIGS. 10 and 11 illustrate a preferred embodiment of a davit and mast base assembly of a third aspect of the invention. In this embodiment, the davit and mast base assembly 60 broadly comprises:
1. the davit base assembly 20 such as that illustrated in FIGS. 1 and 2 adapted to anchor to a roof;
2. the mast base assembly 22 associated with the mast 24 and configured for rotation about the davit base assembly 20.

In the embodiment shown, the mast base assembly 22 includes an external bearing arrangement 62 configured for contact with an outer-facing surface of the sleeve 31 of the davit base assembly 20. The external bearing arrangement 62 includes a plurality of circumferentially spaced roller bearings such as 64a to 64i associated with a bearing housing 66 together located outside of the sleeve 31 of the davit base assembly 20. In this example, there are fewer rollers such as 64a and 64i located under a boom because when the boom is loaded the rollers such as 64c to 64g at the rear of the associated mast take all of the load (not shown). The bearing housing 66 is secured to an annular flange 68 of a mast base 70 of the mast base assembly 22. The bearing housing 66 and the annular flange 68 are thus configured to facilitate rolling contact of the plurality of roller bearings 64a to 64i with the outer-facing surface of the sleeve 31 of the davit base assembly 20.

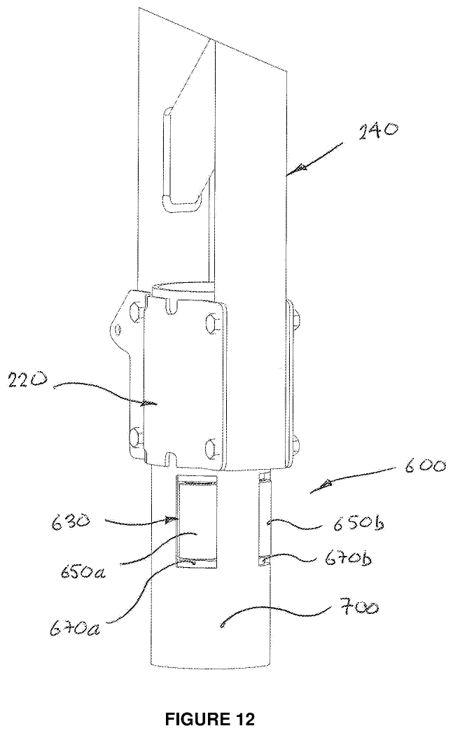

FIG. 12 depicts a preferred embodiment of a davit and mast base assembly of a fourth aspect of the invention. In this embodiment, the davit and mast base assembly 600 broadly comprises:
1. a davit base assembly (not shown) similar to that of the third aspect adapted to anchor to a roof;
2. a mast base assembly 220 associated with a mast 240 and configured for rotation about the davit base assembly.

In this embodiment of the fourth aspect, the mast base assembly 220 includes an internal roller bearing sub-assembly 630 configured for rolling contact with an inner-facing surface of a sleeve of the davit base assembly (not shown). The internal roller bearing sub-assembly 630 includes a plurality of roller bearings such as 650a and 650b spaced circumferentially about the mast base 700 of the mast base assembly 220. The mast base 700 includes a plurality of circumferentially spaced window openings such as 670a and 670b through which respective of the plurality of roller bearings 650a and 650b partly protrude for rolling contact with the inner-facing surface of the sleeve.

Returning to FIG. 10, the mast base 70 of the mast base assembly 22 is configured for location inside the sleeve 31 of the davit base assembly 20. The mast base 70 at its lower end includes an internal bushing 72 configured for rotational mounting about a fixed axle 74 (see FIG. 6) associated with the davit base assembly 20. In an alternative arrangement (not illustrated), the mast base assembly 22 includes an internal bearing arrangement located at the lower end of the mast base 70 for bearing between an internal surface of the sleeve 31 and an outer-facing surface of the mast base 70.

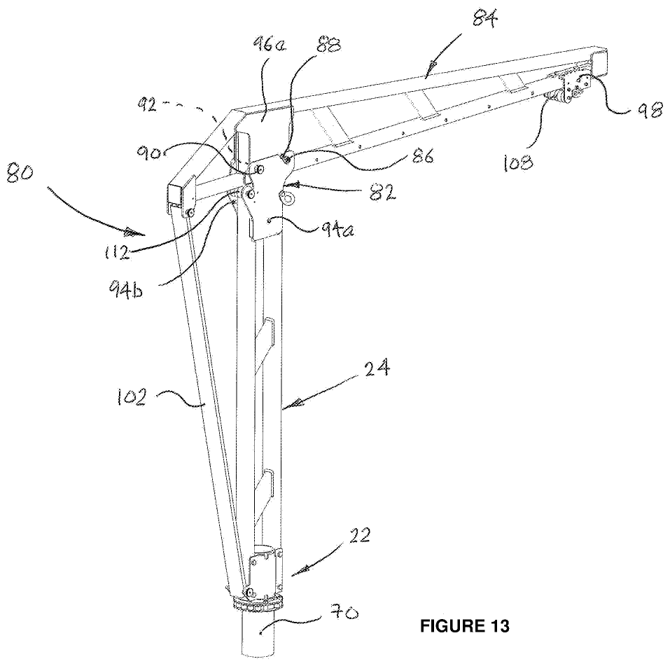

FIGS. 13 to 16 show a demountable mast and boom assembly of a davit of a fifth aspect of the invention. For ease of reference the demountable mast and boom assembly 80 of this embodiment is taken from improved davit of the preferred embodiment of the first aspect of FIGS. 1 and 2. In this embodiment of the fifth aspect, the demountable mast and boom assembly 80 broadly comprises:
1. the mast 24 at its upper end having a boom mounting bracket 82;
2. a removable boom 84 including a tilt pin 86 arranged to slidably cooperate with a slot 88 formed in the boom mounting bracket 82;
3. a locking pin 90 retractably associated with the boom mounting bracket 82 and configured for alignment with a locking aperture 92 of the boom 84 in a raised position (see FIG. 13).

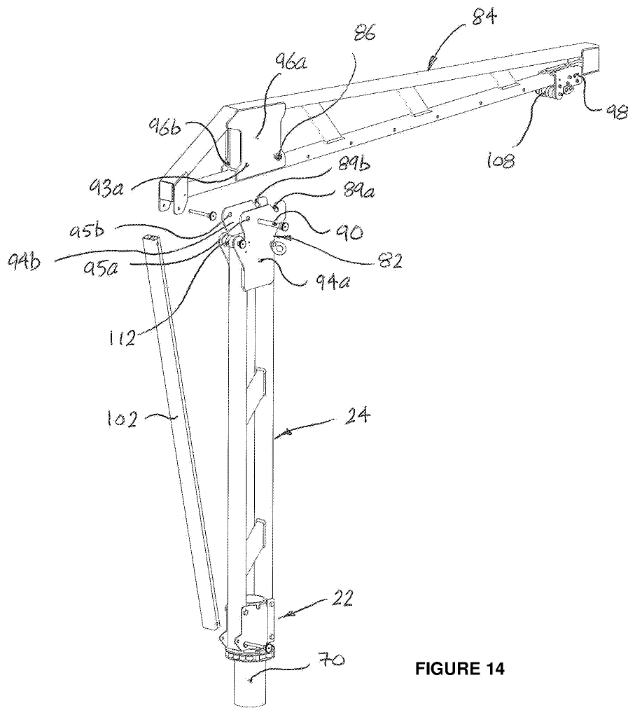

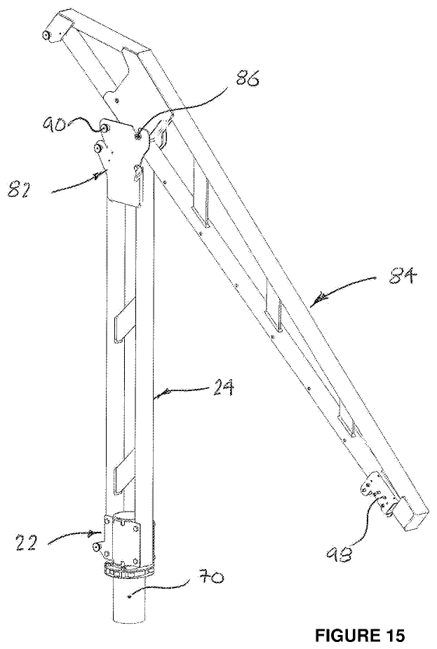

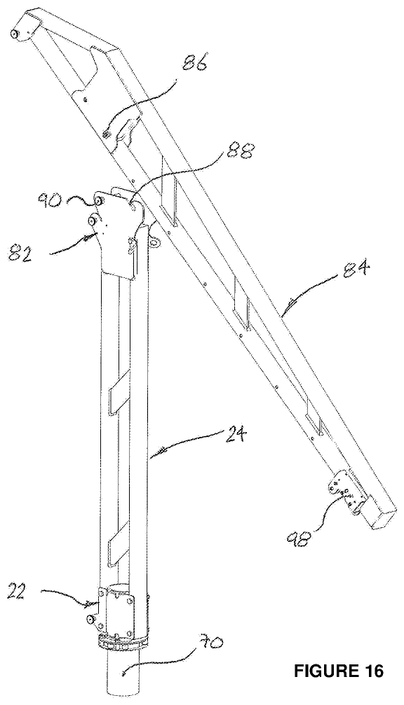

In this embodiment of the fifth aspect, the slot 88 is configured (a) at a closed end for retention of the tilt pin 86 whilst the removable boom 84 is swung about the tilt pin 86 in a substantially vertical plane from a lowered position (see FIG. 15) to the raised position (see FIG. 13) or vice versa, and (b) at an open end for sliding removal of the tilt pin 86 whilst the removable boom 84 in the lowered position is lifted from the boom mounting bracket 82 (see FIG. 16). The boom mounting bracket 82 includes a pair of opposing mounting plates 94a and 94b fixed to the upper end of the mast 24. The opposing mounting plates 94a/b are located either side of a corresponding pair of mounting plates 96a/b associated with the removable boom 84. The slot 88 of the boom mounting bracket 82 is one of a pair of slots 89a and 89b (see FIG. 14) formed in respective of the opposing mounting plates 94a/b. The tilt pin 86 extends between and protrudes either side of the corresponding mounting plates 96a/b of the boom 84. This means the tilt pin 86 at its opposing ends is configured for sliding receipt within the open end of respective of the pair of slots 89a/b.

In this embodiment of the fifth aspect, the tilt pin 86 is longitudinally offset toward a proximal end of the removable boom 84 relative to its centre of gravity. This means the biasing weight forces of the boom 84 promote tilting of the boom 84 toward the lowered position whilst retaining the tilt pin 86 at the closed end of the slot 88 of the boom mounting bracket 82 (see FIG. 15). In this example, the slot 88 of the boom mounting bracket 82 is of an orientation which substantially aligns with a longitudinal axis of the removable boom 84 in the lowered position. This permits sliding removal of the tilt pin 86 from the open end of the slot 88 by lifting of the boom 84 in a general direction of the longitudinal axis of said boom 84 (see FIG. 16).

As best seen in FIGS. 14 and 15, the locking aperture 92 of the removable boom 84 is one of a pair of locking apertures 93a/b formed in respective of the corresponding pair of mounting plates 96a/b of the boom 84. It will be understood that the locking apertures 93a/b are longitudinally spaced from the tilt pin 86 toward the proximal end of the removable boom 84 to effectively secure it in the raised position. The locking pin 90 is retractably received within the a pair of opposing pin apertures 95a/b of the opposing mounting plates 94a/b of the boom mounting bracket 82. It is to be understood that the pin apertures 95a/b align with the pair of corresponding locking apertures 93a/b of the boom 84 to both (i) hold the boom 84 in the raised position, and (ii) retain the tilt pin 86 at the closed end of the slot 88.

Returning to FIGS. 1 and 2, the improved davit 10 may be constructed and assembled in different configurations depending on its application. For example, when installed on a parapet roof the mast such as 24 may be selected from one of two masts of different predetermined heights depending on the height of the parapet. Furthermore, the removable boom such as 84 may be selected from one of three booms of different predetermined lengths depending on the required reach and coverage of the improved davit 10. It will be understood that by increasing the length of the boom 84 the number of davit bases required to provide complete facia coverage is reduced. In the illustrated embodiment of the improved davit 10, the boom 84 and associated shuttle 98 are expected to be of a reach exceeding one metre. Under the expected load of a typical user 100 suspended from the shuttle 98 at its maximum reach, the improved davit 10 of this construction requires a back brace 102 extending between the proximal end of the boom 84 and the mast base assembly 22. Under typical operating and load conditions, it is to be understood that the improved davit 10 and its associated roller bearing arrangement such as 30 enables relatively free rotation of the loaded boom 84 and associated mast 24 about the davit base assembly 20.

The user 100 is in a typical install suspended via primary and secondary lines 104 and 106 in this embodiment dedicated to respective pulleys 108 and 110 mounted to the shuttle 98. The secondary 106 may also turn about another pulley 112 removably detached to the mast 24 at the mounting bracket 82 and either anchored to the mast base 22 or associated with a winch (not shown) associated with the mast 24.

Now that embodiments of the various aspects of the invention have been described it will be apparent to those skilled in the art that the improved davit and the other broader aspects of the invention have at least one or more of the following advantages:
1. the davit base assembly is engineered for effective sliding attachment and removal of the associated removable base sub-assembly;
2. the mounting plate sub-assembly of the davit base assembly with the removable base sub-assembly removed is below the level of the floating tiles or other floor arrangement and thus can be covered by replacement of tiles or other floor coverings;
3. the davit base assembly in interlocking the mounting base sub-assembly and removable base sub-assembly by the defined linear action is less susceptible to disengagement under the influence of twisting forces imposed by rotation of the mast about the davit base assembly;
4. the mast base assembly includes a roller bearing arrangement which is effective in allowing relative free rotation of an associated mast and relatively long boom when loaded at or near its maximum reach;
5. the demountable mast and boom assembly is constructed for assembly and disassembly by a single person with relative ease and reduced risk of WHS or EHS issues.

Those skilled in the art will appreciate that the invention as described herein is susceptible to variations and modifications other than those specifically described. For example, the specific construction of the mast and/or boom may vary from the relatively lightweight truss-style configuration illustrated. The bearing arrangement of the mast base assembly may also depart from the specific embodiments described provided the associated davit effectively rotates under load. The demountable mast and boom assembly may reverse the tilt pin and cooperating slot where the tilt pin is connected to the upper end of the mast and the cooperating slot is formed in the boom.

All such variations and modifications are to be considered within the scope of the present invention the nature of which is to be determined from the foregoing description.

1. A davit, comprising:
a davit base assembly comprising:
a removable base sub-assembly including securement means configured to cooperate with the mounting plate sub-assembly wherein sliding movement of the removable base sub-assembly in a linear action effects movement of the securement means into an engaged position for securement of the removable base sub-assembly to the mounting plate sub-assembly, said securement means configured wherein sliding movement of said base sub-assembly in a reciprocal linear action effects movement of said securement means into a disengaged position where the removable base sub-assembly is released for removal from the mounting plate sub-assembly; and
a mast base assembly associated with a mast and configured for rotation about the davit base assembly, said mast base assembly including a roller bearing arrangement configured for contact with a sleeve of the removable base sub-assembly during rotation of the mast and the associated mast base assembly about the davit base assembly.

2. The davit as claimed in claim 1, wherein the roller bearing arrangement is an external roller bearing arrangement configured for contact with an out-facing surface of the sleeve of the removable base sub-assembly, the external roller bearing arrangement including an upper roller bearing sub-assembly including a plurality of circumferentially spaced roller bearings associated with a bearing housing located outside of the sleeve of the davit base sub-assembly, said bearing housing secured to an annular flange of the mast base assembly.

3. The davit as claimed in claim 1, wherein the roller bearing arrangement includes an internal roller bearing sub-assembly having a plurality of roller bearings spaced circumferentially about a mast base of the mast base assembly, the mast base including a plurality of circumferentially spaced window openings through which respective roller bearings of the plurality of roller bearings partly protrude for rolling contact with the inner-facing surface of the sleeve of the davit base assembly.

4. The davit as claimed in claim 1, wherein the removable base sub-assembly also includes a locking arrangement configured to cooperate with the mounting plate sub-assembly for movement into a locked position to prevent sliding movement of the removable base sub-assembly thereby retaining the securement means in the engaged position.

5. The davit as claimed in claim 4, wherein the locking arrangement includes a retractable plunger arranged to engage a corresponding aperture in the mounting plate sub-assembly to prevent sliding movement of the removable bae sub-assembly whilst the securement means is in the engaged position, the locking arrangement also including biasing means configured to urge the retractable plunger into engagement with the aperture of the mounting plate sub-assembly.

6. The davit as claimed in claim 1, wherein the securement means includes a plurality of key elements fixed to and projecting from the removable base sub-assembly, each of said key elements configured for sliding movement in the linear and reciprocal linear actions within a respective keyway of a plurality of keyways formed in the mounting plate sub-assembly.

7. The davit as claimed in claim 6, wherein each of the keyways is in the form of a keyhole slot configured at an enlarged end for passage of a corresponding key element of the key elements in the disengaged position of the securement means, the keyhole slot at an opposing tapered end being effective in retaining the key element for securement of the removable base sub-assembly to the mounting plate sub-assembly in the engaged position of the securement means.

8. The davit as claimed in claim 6, wherein the removable base sub-assembly includes a sleeve connected to an end plate, the sleeve being adapted to receive and support the mast base assembly, the removable base sub-assembly also including a plurality of radially projecting gussets located outside the sleeve and connected between the end plate and the sleeve to support the removable base sub-assembly under load imposed by the mast base assembly.

9. The davit as claimed in claim 8, wherein the key elements of the securement means are fixed to and extend from either the end plate or two or more of the gussets for securement of the removable base sub-assembly to the mounting plate sub-assembly via the securement means in the engaged position.

10. The davit as claimed in claim 1, wherein the securement means includes a plurality of keyways formed in the removable base sub-assembly, said keyways configured for movement between the engaged and disengaged positions relative to a respective key element of a plurality of key elements fixed to and projecting from the mounting plate sub-assembly.

11. The davit as claimed in claim 1, wherein the mounting plate sub-assembly includes an upper plate to which two or more lower mounting rails are fixed, said mounting rails adapted for anchoring to the roof via one or more anchorages whilst providing a space between the roof and an underside of the upper plate to accommodate the securement means of the removable base sub-assembly during sliding movement of the removable base sub-assembly and the associated movement of the securement means between the disengaged and engaged portions.

12. The davit as claimed in claim 11, wherein the upper plate includes one or more anchorage openings for passage of a respective anchorage of the one or more anchorages into the corresponding mounting rail for anchoring of the mounting plate sub-assembly to the roof with the anchorages being located below an upper surface of the upper plate.

13. A davit and mast base assembly, comprising:
a davit base assembly adapted to anchor to a roof; and
a mast base assembly associated with a mast and configured for rotation about the davit base assembly, said mast base assembly including an external bearing arrangement configured for contact with an outer-facing surface of a sleeve of the davit base assembly during rotation of the mast and the associated mast base assembly about the davit base assembly.

14. The davit and mast base assembly as claimed in claim 13, wherein the external bearing arrangement includes an upper roller bearing sub-assembly including a plurality of circumferentially spaced roller bearings associated with a bearing housing located outside of the sleeve of the davit base sub-assembly, said bearing housing secured to an annular flange of a mast base of the mast base assembly.

15. The davit and mast base assembly as claimed in claim 14, wherein the bearing housing and the annular flange are configured to facilitate rolling contact of the plurality of roller bearings with the outer-facing surface of the sleeve of the davit base assembly.

16. A davit and mast base assembly, comprising:
a davit base assembly adapted to anchor to a roof; and
a mast base assembly associated with a mast and configured for rotation about the davit base assembly, said mast base assembly including an internal roller bearing sub-assembly configured for rolling contact with an inner-facing surface of a sleeve of the davit base assembly during rotation of the mast and the associated mast base assembly about the davit base assembly.

17. The davit and mast base assembly as claimed in claim 16, wherein the internal roller bearing sub-assembly includes a plurality of roller bearings spaced circumferentially about a mast base of the mast base assembly.

18. The davit and mast base assembly as claimed in claim 17, wherein the mast base includes a plurality of circumferentially spaced window openings through which respective roller bearings of the plurality of roller bearings partly protrude for rolling contact with the inner-facing surface of the sleeve of the davit base assembly.

19. The davit and mast base assembly as claimed in claim 16, wherein a mast base of the mast base assembly at its lower end is located inside the sleeve of the davit base assembly, and includes an internal bushing configured for rotational mounting about a fixed axle associated with the davit base assembly.

20. The davit and mast base assembly as claimed in claim 16, wherein a mast base of the mast base assembly at its lower end is located inside the sleeve of the davit base assembly, and includes an internal bushing configured for rotational mounting about a fixed axle associated with the davit base assembly.
